(19) United States
(12) Patent Application Publication
(10) Pub. No.: US 2005/0071475 A1
(43) Pub. Date: Mar. 31, 2005

(54) Direct internet access in the global system for mobile communications

(76) Inventors: Donald John Bennett, Naperville, IL (US); Gerard Joseph Polfer, Big Rock, IL (US)

Correspondence Address: PATTON BOGGS, 1660 LINCOLN ST, SUITE 2050, DENVER, CO, 80264, US

(21) Appl. No.: 10/674,214

(22) Filed: Sep. 29, 2003

(51) Int. Cl. G06F 15/16

(52) U.S. Cl. 709/227

(57) ABSTRACT

The Direct Internet Access system makes use of an L2TP/UDP/IP connection to the Internet via a L2TP Network Server and the existing Local Area Network or Wide Area Network of the cellular communication network. This system uses a Layer 2 Tunneling Protocol which provides a virtual dial-up access to corporate gateways by extending the dial-up connection that is established between the mobile subscriber station and the Mobile Switching Center to the Internet or a corporate gateway over the Internet. The user has an L2 connection to an access concentrator in the Mobile Switching Center, which then tunnels individual Point-to-Point Protocol frames to the L2TP Network Server, so that the packets can be processed separately from the location of the circuit termination. This means that the mobile subscriber station call connection can terminate at a local circuit concentrator in the Mobile Switching Center, eliminating possible long-distance charges, among other benefits.

### FIELD OF THE INVENTION

This invention relates to mobile communication systems and in particular to a system for providing direct access to the Internet in a Global System for Mobile Communications network.

### Problem

It is a problem in the field of cellular communications to obtain efficient and cost-effective access to the Internet as well as to obtain access to remote locations via the Internet. For example, remote access to services provided via a corporate network is traditionally accomplished by the use of dial up access, which imposes numerous problems for corporate networks, such as the infrastructure and operational costs of such an access method. Existing Internet access paradigms involve the added cost and complexity of an Internet Service Provider or ISDN Primary Rate Access connection. These types of connections can be complex to set up and involve a monthly fee that must be paid to a service provider. In addition, the call connection from a mobile subscriber station to the corporate network may entail long distance charges.

### Solution

The above described problems are solved and a technical advance achieved by the present Direct InternetAccess system, which makes use of an L2TP/UDP/IP connection to the Internet via a L2TP Network Server and the existing Local Area Network or Wide Area Network of the cellular communication network. This system uses a Layer 2 Tunneling Protocol which provides a virtual dial-up access to corporate gateways by extending the dial-up connection that is established between the mobile subscriber station and the Mobile Switching Center to the corporate gateway over the Internet. The Layer 2 Tunneling Protocol uses packet-switched network connections to make it possible for the endpoints to be located on different machines. The user has an L2 connection to an access concentrator in the Mobile Switching Center, which then tunnels individual Point-to-Point Protocol frames to the L2TP Network Server, so that the packets can be processed separately from the location of the circuit termination. This means that the mobile subscriber station call connection can terminate at a local circuit concentrator in the Mobile Switching Center, eliminating possible long-distance charges, among other benefits.

The Local Area Network or Wide Area Network resources are normally already available in the cellular communication network so that no additional fees to the subscriber are involved. In addition, for a 3.1 kHz data call (e.g., Mobile Internet) in a Global System for Mobile Communications network, the call connection time is much faster (typically 1 to 2 seconds) when the L2TP/UDP/IP connection for Direct Internet Access is used compared to the ISUP/ISDN Primary Rate connection presently available (typically 20 to 30 seconds). Also, the existing cellular communication networks utilize a Remote Access Server (RAS) which is more costly than the L2TP Network Server used for Direct Internet Access.

### BRIEF DESCRIPTION OF THE DRAWINGS

FIG. 1 illustrates in block diagram form the overall architecture of the present Direct Internet Access system and an environment in which it is operational; and

FIG. 2 illustrates in block diagram form the architecture of an existing wireless network that serves to interconnect customer premise equipment with the Internet.

### DETAILED DESCRIPTION OF THE DRAWINGS

It is a problem in the field of communications to obtain efficient and cost-effective access to the Internet as well as to obtain access to remote locations via the Internet. For example, remote access to services provided via a corporate network is traditionally accomplished by the use of dial up access, which imposes numerous problems for corporate networks, such as the infrastructure and operational costs of such an access method.

Existing Internet Access Systems

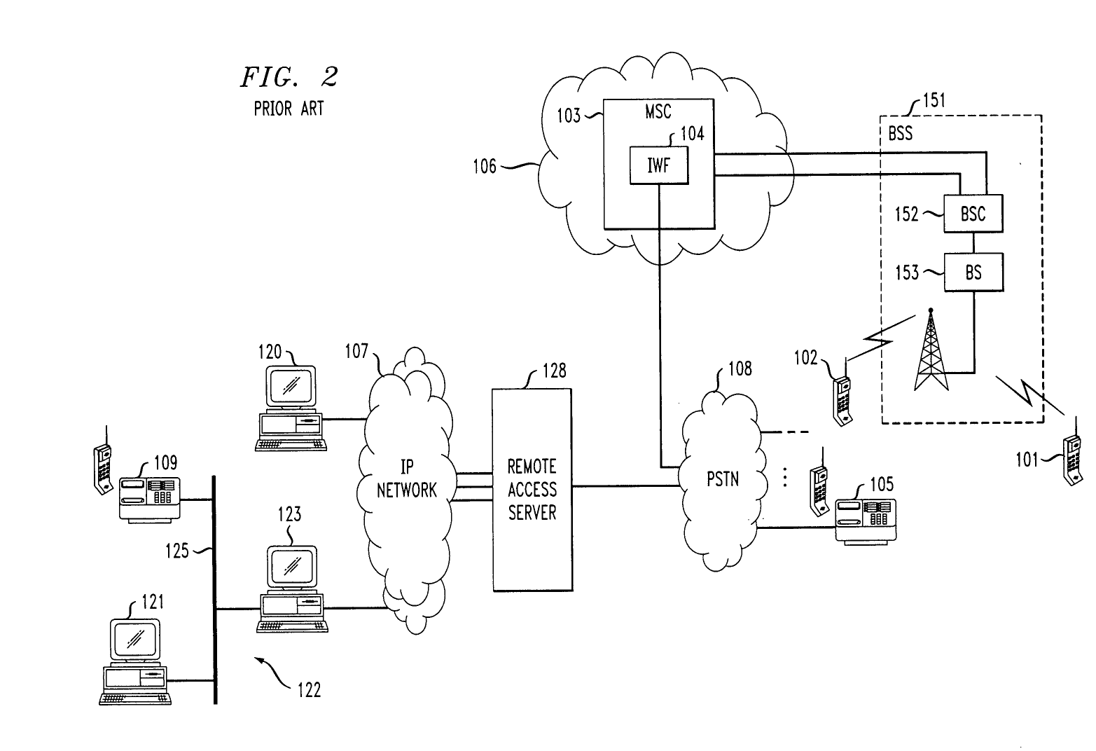

FIG. 2 illustrates in block diagram form the architecture of an existing wireless network that serves to interconnect customer premise equipment with the Internet. Cellular communication networks 106 as shown in block diagram form in FIG. 2 provides the service of connecting wireless telecommunication customers, each having a mobile subscriber station, to both land-based customers 105 who are served by the Public Switched Telephone Network (PSTN) 108 as well as other wireless telecommunication customers 102. In such a network, all incoming and outgoing calls are routed through Mobile Switching Centers (MSC) 103, each of which is connected to a plurality of Base Station Subsystems (BSS) 151 which communicate with mobile subscriber stations 101 located in the area covered by the cell sites. The mobile subscriber stations 101 are served by the Base Station Subsystems (BSS) 151, each of which is located in one cell area of a larger service region. Each cell site in the service region is connected by a group of communication links to the Mobile Switching Center 103. Each cell site contains a group of radio transmitters and receivers, termed a Base Station (BS) 153 herein, with each transmitter-receiver pair being connected to one communication link. Each transmitter-receiver pair operates on a pair of radio frequencies to create a communication channel: one frequency to transmit radio signals to the mobile subscriber station and the other frequency to receive radio signals from the mobile subscriber station. The Mobile Switching Center 103, in conjunction with the Home Location Register (HLR) and the Visitor Location Register (VLR) of the Mobile Switching Center 103, manages subscriber registration, subscriber authentication, and the provision of wireless services such as voice mail, call forwarding, roaming validation and so on. The Mobile Switching Center 103 is connected to an Interworking Function 104 which serves to interconnect the Mobile Switching Center 103 with the Public Switched Telephone Network (PSTN) 108. In addition, the Interworking Function 104 is connected to a Remote Access Server 128 which provides access to the Internet.

The voice communications between mobile subscriber station 101 and other subscriber stations, such as land line based subscriber station 105, is effected by routing the communications received from the mobile subscriber station 101 through the Mobile Switching Center 103 and trunks to the Public Switched Telephone Network (PSTN) 108 where the communications are routed to a Local Exchange Carrier (not shown) that serves land line based subscriber station 105. There are numerous Mobile Switching Centers 103 that are connected to the Public Switched Telephone Network (PSTN) 108 to thereby enable subscribers at both land line based subscriber stations and mobile subscriber stations to communicate between selected stations thereof. Data communications between mobile subscriber station 101 and other data communication systems, such as server 120 or corporate network 122, is effected by routing the data communications received from the mobile subscriber station 101 through Mobile Switching Center 103, Interworking Function 104 and Remote Access Server 128 via an ISUP/ISDN Primary Rate connection. The corporate network 122 typically comprises a corporate gateway server 123, which connects data communications received from the Internet 107 to various servers 121 and terminal devices 109 via an internal Local Area Network 125. This architecture represents the present architecture of the wireless and wire-line communication networks.

In this network architecture, the data communications from mobile subscriber station 101 to the Internet (through an Internet Service Provider) or a corporate network 122 must be switched through the Remote Access Server 128 to the Internet 107. The dial-up access to the corporate gateway 122 through Remote Access Server 128 can be a long distance call to the corporate office. To achieve reasonable data rates, the wire-line connection from the Remote Access Server 128 to the Internet 107 must be a high data rate line with its associated costs, such as an ISUP/ISDN Primary Rate connection.

Direct Internet Access

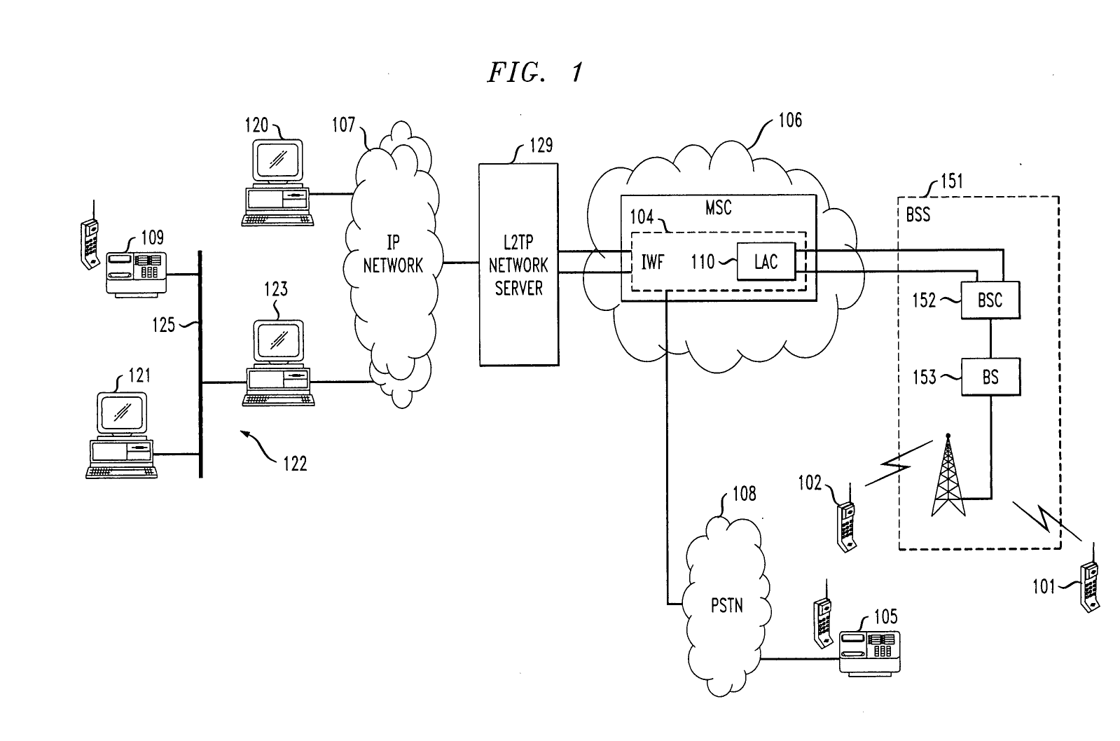

FIG. 1 illustrates in block diagram form the overall architecture of the present Direct Internet Access system and an environment in which it is operational to connect the mobile subscriber 101 to the Internet 107 as well as to obtain access to remote locations 122 via the Internet 107 by use of a L2TP Network Server 129 and an associated L2TP/UDP/IP connection. The introduction and use of Layer 2 Tunneling Protocol (L2TP) on the Mobile Communications Network Inter-Working Function (IWF) 104 is what makes Direct Internet Access possible. Other industry standard tunneling protocols include Point to Point Tunneling Protocol (PPTP) and Layer 2 Forwarding (L2F) and these or other equivalent protocols can be used in this architecture. For a 3.1 kHz data call (e.g., Mobile Internet) in a Global System for Mobile Communications network, the call connection time is much faster (typically 1 to 2 seconds) when the L2TP/UDP/IP connection for Direct Internet Access is used compared to the ISUP/ISDN Primary Rate connection presently available (typically 20 to 30 seconds).

Layer Two Tunneling Protocol (L2TP) is an extension of the Point-to-Point Tunneling Protocol (PPTP) used by an Internet Service Provider (ISP) to enable the operation of a virtual private network (VPN) over the Internet. Layer 2 Tunneling Protocol merges the best features of two other tunneling protocols: PPTP from Microsoft and L2F from Cisco Systems. The two main components that make up Layer 2 Tunneling Protocol are the L2TP Access Concentrator (LAC), which is the device that physically terminates a call within the Interworking Function 104 and the L2TP Network Server (L2TP Network Server) 129, which is the device that terminates and possibly authenticates the Point-to-Point Protocol stream. Layer 2 Tunneling Protocol, for example, provides a virtual dial-up access to corporate gateways 123 by extending the dial-up connection that is established between the mobile subscriber station 101 and the Mobile Switching Center 103 to the corporate gateway 123 over the Internet 107. Layer 2 Tunneling Protocol uses packet-switched network connections to make it possible for the endpoints to be located on different machines. The mobile subscriber station 101 has an L2 connection to a local access concentrator located in the Mobile Switching Center 103, which then tunnels individual Point-to-Point Protocol frames to the Network Access Server at the corporate gateway 123, so that the packets can be processed separately from the location of the circuit termination. This means that the connection can terminate at a Mobile Switching Center 103, eliminating possible long-distance charges, among other benefits. From the user's point of view, there is no difference in the operation.

This architecture is economical because the user only needs to establish a local call to the Mobile Switching Center 103, rather than a long distance call to the corporate gateway 123. The data is carried from the Interworking Function 104 to the L2TP Network Server 129 over the Wireless Service Provider's LAN/WAN. The corporate gateway 123 functions to provide the authentication and secure access functionality while the L2TP tunnels the link layer of the Point to Point Protocol over any media, which provides a point-to-point connectivity that is analogous to that provided by the Internet, Frame Relay, or ATM networks. The use of Layer 2 Tunneling Protocol tunnels divorces the location of the initial dial-up server from the location at which the dial-up protocol connection is terminated and provides access to the corporate network 122. The virtual dial-up access thus implemented results in substantial cost-savings for corporate networks.

The L2TP Network Server 129 assigns a subscriber session to a Virtual Routing and Forwarding (VRF) instance and routes the session within the Virtual Routing and Forwarding instance to the destination corporate network 122. A subscriber initiates a session to the Mobile Switching Center's access server, which is termed the Layer 2 Tunneling Protocol Access Concentrator (LAC) 110. The Layer 2 Tunneling Protocol Access Concentrator 110 directs the sessions into L2TP tunnels based on the domain of each session. The L2TP Network Server 129 terminates the L2TP sessions and places them in the appropriate Virtual Routing and Forwarding (VRF) instances based on the L2TP tunnel. The Layer 2 Tunneling Protocol Access Concentrator 110 obtains information about the L2TP Network Server 129 that is attached to the corporate gateway 123. Layer 2 Tunneling Protocol Access Concentrator 110 establishes a tunnel with L2TP Network Server 129 over the Internet. Once the tunnel is established, Layer 2 Tunneling Protocol Access Concentrator 110 allocates a Call ID and notifies L2TP Network Server 129 about the new connection. The notification contains all the information required for the L2TP Network Server 129 to authenticate the user, and the LCP options that have been negotiated between the remote user and Layer 2 Tunneling Protocol Access Concentrator (LAC) 110. If L2TP Network Server 129 accepts this connection, it creates a virtual interface for Point to Point Protocol in a manner analogous to what it would use for a direct-dialed connection. The LCP options negotiated between the remote user and Layer 2 Tunneling Protocol Access Concentrator 110 is used for this virtual Point to Point Protocol interface.

In addition, Layer 2 Tunneling Protocol provides:
An extensible control protocol for dynamic setup, maintenance, and teardown of multiple layer 2 tunnels between two logical endpoints.
An encapsulation method for tunneling Point-to-Point Protocol frames between each endpoint. This includes multiplexing of multiple, discrete, Point-to-Point Protocol streams between each endpoint.
   L2TP Access Concentrator (LAC)

L2TP Access Concentrator 110 is node that acts as one side of an L2TP tunnel endpoint and is a peer to the L2TP Network Server (LNS) 129. The L2TP Access Concentrator 110 sits between an L2TP Network Server 129 and a mobile subscriber station 101 and forwards packets to and from mobile subscriber station 101. Packets sent from the L2TP Access Concentrator 110 to the L2TP Network Server 129 require tunneling with the Layer 2 Tunneling Protocol as defined above. The connection from the L2TP Access Concentrator 110 to the mobile subscriber station 101 is a local link.

L2TP Network Server (LNS)

L2TP Network Server (LNS) 129 is a node that acts as one side of an L2TP tunnel endpoint and is a peer to the L2TP Access Concentrator (LAC) 110. The L2TP Network Server 129 is the logical termination point of a Point-to-Point Protocol session that is being tunneled from the mobile subscriber station 101 by the L2TP Access Concentrator 110.

Session

Layer 2 Tunneling Protocol is connection-oriented. The L2TP Network Server 129 and L2TP Access Concentrator 110 maintain state for each call that is initiated or answered by a L2TP Access Concentrator 110. An L2TP Session is created between the L2TP Access Concentrator 110 and L2TP Network Server 129 when an end-to-end Point-to-Point Protocol connection is established between mobile subscriber station 101 and the L2TP Network Server 129. Data-grams related to the Point-to-Point Protocol connection are sent over the Tunnel between the L2TP Access Concentrator 110 and L2TP Network Server 129. There is a one to one relationship between established L2TP Sessions and their associated calls. Tunnel

A Tunnel exists between a L2TP Access Concentrator 110-L2TP Network Server 129 pair. The Tunnel consists of a Control Connection and zero or more L2TP Sessions. The Tunnel carries encapsulated Point-to-Point Protocol data-grams and Control Messages between the L2TP Access Concentrator 110 and the L2TP Network Server 129.

Tunnel Endpoint Security

The tunnel endpoints may optionally perform an authentication procedure of one another during tunnel establishment. For a uthentication to occur, the L2TP Access Concentrator 110 and L2TP Network Server 129 must share a single secret. Each side uses this same secret when acting as authenticate as well as authenticator.

Packet Level Security

Securing Layer 2 Tunneling Protocol requires that the underlying transport make available encryption, integrity and authentication services for all Layer 2 Tunneling Protocol traffic. This secure transport operates on the entire L2TP packet and is functionally independent of Point-to-Point Protocol and the protocol being carried by Point-to-Point Protocol. As such, Layer 2 Tunneling Protocol is only concerned with confidentiality, authenticity, and integrity of the Layer 2 Tunneling Protocol packets between its tunnel endpoints (the L2TP Access Concentrator 110 and L2TP Network Server 129), not unlike link-layer encryption being concerned only about protecting the confidentiality of traffic between its physical endpoints.

Summary

The Direct Internet Access system makes use of an L2TP/UDP/IP connection to the Internet. Layer 2 Tunneling Protocol provides a virtual dial-up access to the Internet or corporate gateways by extending the dial-up connection that is established between the mobile subscriber station and the Mobile Switching Center to the Internet or to the corporate gateway over the Internet.

1. A Direct Internet Access system for providing a subscriber with virtual dial-up access to corporate gateway from a mobile subscriber station, comprising:
means for establishing a call connection between a mobile switching center and a mobile subscriber station;
network server means, located in said mobile switching center, for establishing a data session with a destination network interface; and
means for establishing a tunnel with said destination network interface

2. The Direct Internet Access system of claim 1 wherein said network server means comprises:
means for assigning a subscriber session to a Virtual Routing and Forwarding (VRF) instance; and
means for routing said subscriber session within the Virtual Routing and Forwarding instance to the destination network interface.

3. The Direct Internet Access system of claim 1 wherein said network server means comprises:
means for authenticating said mobile subscriber station.

4. The Direct Internet Access system of claim 1 wherein said means for establishing a tunnel comprises:
L2TP Access Concentrator means for allocating a Call ID and notifying said network server means about the new connection.

5. A method for providing a subscriber with virtual dial-up access to corporate gateway from a mobile subscriber station, comprising:
establishing a call connection between a mobile switching center and a mobile subscriber station;
establishing, in said mobile switching center, a data session with a destination network interface; and
establishing a tunnel with said destination network interface

6. The Direct Internet Access method of claim 5 wherein said step of establishing a data session comprises:
assigning a subscriber session to a Virtual Routing and Forwarding (VRF) instance; and
routing said subscriber session within the Virtual Routing and Forwarding instance to the destination network interface.

7. The Direct Internet Access method of claim 5 wherein said step of establishing a data session comprises:
authenticating said mobile subscriber station.

8. The Direct Internet Access method of claim 5 wherein said step of establishing a tunnel comprises:
allocating in a L2TP Access Concentrator a Call ID and notifying said network server means about the new connection.
